(19) United States
(12) Patent Application Publication
(10) Pub. No.: US 2008/0050059 A1
(43) Pub. Date: Feb. 28, 2008

(54) Bearing with Reduced Reflow

(75) Inventors: Pieter Martin Lugt, Vianen (NL); John Howard Tripp, Cleveland Heights, OH (US)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 10/572,207

(22) PCT Filed: Sep. 20, 2004
(86) PCT No.: PCT/NL04/00648

§ 371 Date: Mar. 12, 2007

(30) Foreign Application Priority Data
Sep. 18, 2003 (NL) 1024322

(51) Int. Cl. F16C 33/66

(52) U.S. Cl. 384/462

(57) ABSTRACT

A method for lubricating the rolling contacts in a rolling element bearing having at least two rings which are each provided with raceways, as well as a at least one series of rolling elements which are in contact with the raceways, comprises the steps of providing the raceway surface of at least one of the rings and rolling elements with a pattern which has a dominant oblique characteristic in relation to the axis of the bearing, providing a lubricant on the raceway surface, and making the rolling elements overroll over the patterned raceway surface over at least the full circumference of the raceway so as to displace the lubricant in the axial direction under the influence of the engagement of the rolling elements with the pattern.

The invention is related to the field of rolling element bearings. Such bearings are applied in numerous fields, e.g. in the automotive industry, mills etc. In normal operation, the lubricant is sheared into the contact between the rollers and the raceways as a result of the speed of the surfaces thereof. Due to this so-called elasto-hydrodynamic lubrication, rollers and the raceways are separated by a lubricant film which is build up by hydrodynamic action. Such a lubricant film is of importance for obtaining a proper function of the roller bearing.

However, because of the high magnitude of the pressures in the contacts, backflow occurs which results in a thinner lubricant film. The pressure outside the bearing, in particular outside the contacts, is lower than in the contacts. This has the effect that there is a trend to expel the lubricant out of the contacts. The viscous shear causes the build up of this film. An optimum film is strongly determined by the thickness of the layers of lubricant in front of the contacts, which forms the supply of lubricants. If the supply is limited, which generally occurs in case of grease lubrication, high speed or very high viscosity lubrication, so-called starved lubrication occurs. A reduced firm is formed which may lead to metal-to-metal contact and a reduced bearing life. This reduction in lubricant layer in front of the contact is amongst other caused by a side flow.

The object of the invention is to provide a solution to this problem. This solution is obtained through a method for lubricating the rolling contacts in a rolling bearing having at least two rings which are each provided with raceways, as well as a at least one series of rolling elements which are in contact with said raceways, comprising the steps of:

providing the raceway surface of at least one of the rings with a pattern which has an oblique characteristic in relation to the axis of the bearing,

providing a lubricant on said raceway surface,

making the rolling elements overroll over said patterned raceway surface over at least the fill circumference of said raceway so as to displace the lubricant in axial direction under the influence of the engagement of the rolling elements with said pattern.

Due to the fact that the rolling elements overroll the oblique pattern, the wave of lubricant which is dynamically formed before the rolling element does not only have a component of motion in the rolling direction, but also a component of motion transverse to the rolling direction. Thus, the lubricant is driven somewhat in sideward direction with respect to the rolling direction. This phenomenon can be fruitfully applied to direct the lubricant in a certain desired direction, for instance opposite to the pressure induced motion of the lubricant. In particular in the case of starved lubrication conditions this effect is beneficial.

The pattern can have several shapes, but preferably the method according to the invention comprises the step of providing said raceway surface with a pattern which has screw type and/or spiral type characteristics. In particular, the pattern can be obtained by the step of providing a grooved pattern.

Furthermore, the invention can comprise the step of providing a first grooved pattern on one part of the raceway surface, and a second grooved pattern on another part of the raceway surface, which raceway surface parts are next to each other in axial direction and which have oppositely oriented oblique patterns. In this way, the pressure induced loss of lubricant can be counteracted from both axial ends of the bearing.

The invention is furthermore related to a rolling element bearing which is lubricated according to the method described before, comprising at least two rings which are each provided with raceways, as well as a at least one series of rolling elements which are in contact with said raceways, the raceway surface of at least one of the rings being provided with a pattern which has an oblique characteristic in relation to the axis of the bearing. In particular, the raceway surface can have a pattern which has screw type and/or spiral type characteristics. The rolling elements may also have such a pattern.

The raceway surface preferably has a grooved pattern. In a particular embodiment described before, a first grooved pattern may be provided on one part of the raceway surface, and a second grooved pattern on another part of the raceway surface, which raceway surface parts are next to each other in axial direction and which have oppositely oriented oblique patterns.

Such oppositely oriented oblique patterns are in particular fit for application in a line contact type of rolling element bearing, e.g. a tapered roller, a cylindrical roller bearing, a spherical roller bearing etc. For other bearings, other patterns appear to be beneficial. For instance, a spiral type groove pattern can be provided in connection with a tapered rolling bearing. In such case, the rolling direction of the bearing is selected in such a way that the lubricant is driven towards the small diameter end of the bearing. Thereby, the spiral type groove pattern counteracts the tendency of the lubricant to flow towards the large diameter and under the influence of centrifugal forces which occur upon rotation in the bearing.

The oil is squeezed in the nip between the rolling element and the raceway. As a result, the oil is transported along the grooves in the desired direction.

Furthermore, the dominant oblique structure may comprise curved grooves, e.g. grooves which stretch over an arc of about 90°. One end of the arc is about parallel to the rolling direction, the other end about perpendicular thereto. Of course, grooves stretching over an arc smaller than 90° are flexible as well; the ends of the grooves in that case may be non parallel or non perpendicular with respect to the rolling direction. Also an arc of about 180° is possible, the top thereof pointing in the running direction.

The invention will now be described further with reference to an embodiment shown in the drawings.

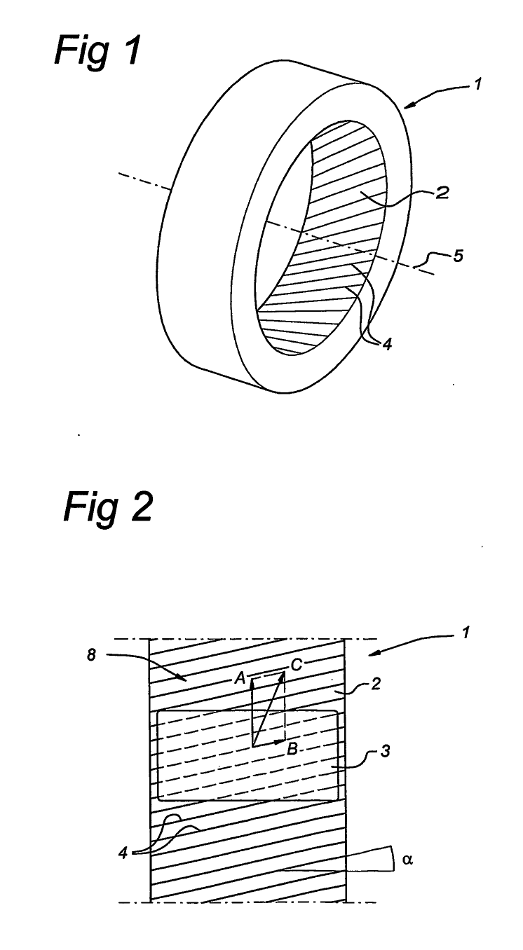

FIG. 1 shows a view in perspective of an outer bearing ring according to the invention.

FIG. 2 shows a top view on the raceway of the bearing ring according to FIG. 1, together with a roller.

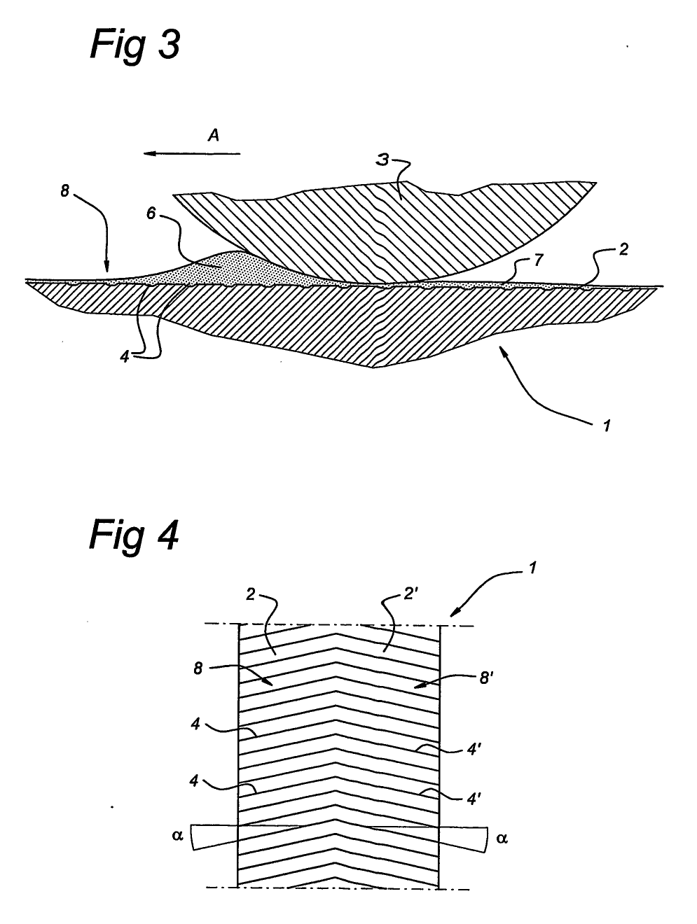

FIG. 3 shows a cross section through part of a roller and the raceway of the bearing ring.

FIG. 4 shows a further embodiment.

The bearing ring 1 as shown in FIG. 1 comprises a raceway 2. The bearing ring 1 in question has to be assembled with an inner ring and a series of rollers one of which is shown in the top view of FIG. 2. The said FIG. 2 shows only one roller, but it is to be understood that of course a series of rollers extends in the circumferential direction of bearing ring 1.

As shown in the figures, the raceway surface 2 has a regular pattern of oblique grooves 4, which make an angle a which is lying between zero en ninety degrees with respect to the axis 5 of the bearing ring. Although the grooves shown are straight also curved grooves can be applied.

As is usual, during the rolling action of the roller 3 in the direction of the arrow of FIG. 3 over the raceway surface 2 of the bearing ring 1 a wave of oil is driven forward over said raceway surface. The oil forms a lubricant layer 7 on top of the raceway surface 2, in such a way that there is no direct physical contact between the roller 3 and the bearing ring 1.

The proper function of the bearing in question is ensured as soon as a sufficient thickness of the lubricant film 7 between the rollers 3 and the bearing ring is maintained. However, under poor lubrication conditions, the lubricant tends to be squeezed out of the contact between the roller 3 and the bearing ring 1. Thus, the oil or grease is expelled towards the axially outer sides of the bearing ring. With the aim of promoting a lubricant flow over the raceway surface in such a way that also the middle part thereof is sufficiently lubricated, a pattern 8 of the oblique lines 9 has been applied on the bearing surface. The effect of this pattern 8 is explained as follows.

As shown in FIG. 2, the roller 3 rolls in de direction of the arrow A over de raceway surface 2. As a consequence of the oblique orientation of the grooves 4, thereby the oil in the wave 6 is also driven in direction B, resulting in a general speed and direction of the oil as indicated with the arrow C. It is clear that thereby another flow, transverse and towards the middle part of the raceway surface, is obtained.

It is also possible to apply a pattern which has an arrow shape, whereby the point of the arrow is in the axial middle of the bearing surface. In the embodiment of FIG. 4, the pattern 8 has grooves 4, 4′ which have respective angles with respect to the axis 5 of the bearing which are equal to α and −α. Thereby a chevron type pattern 8 is obtained, in which the lubricant is driven towards the axial middle part of the bearing ring 1 from both axial sides thereof. The result is a decrease in lubricant sideflow and consequently an increase in bearing life.

The invention contributes to the extension of relubrication intervals in the case of grease lubrication. The transport of oil, which is led from the grease which is partly sitting at the side of the rollers, towards and inside the running track(s) is promoted.

Although in the embodiments shown in the figures, straight grooves are shown, it is also possible top apply curved grooves. For instance, in the embodiment of FIG. 4 the arrow shaped grooves may be replaced by grooves which stretch according to an arc, the top of which being situated near the top of the arrow. The arc may stretch over 180°, the ends thereof then pointing downwards in the embodiment of FIG. 4. Smaller angled arcs are also possible of course.

1. Method for lubricating rolling contacts in a roiling element bearing having at least two rings which are each provided with raceways, as well as at least one series of rolling elements which are in contact with said raceways, comprising the steps of:
providing the raceway surface of at least one of the rings and rolling elements with a pattern which has a dominant oblique characteristic in relation to the axis of the bearing,
providing a lubricant on said raceway surface,
making the rolling elements overroll over said patterned raceway surface over at least the full circumference of said raceway so as to displace the lubricant in axial direction under the influence of the engagement of the rolling elements with said pattern.

2. Method according to claim 1, comprising the step of providing one and only one oblique characteristic in relation to the axis of the bearing.

3. Method according to claim 1, comprising the step of providing at least one oblique characteristic which is more dominant than another oblique characteristic.

4. Method according to claim 1, comprising the step of providing a dominant oblique characteristic on a ring shaped part of the raceway surface, and a different characteristic on a further ring shaped part of the raceway.

5. Method according to claim 4, comprising the step of providing the further ring shaped part of the raceway with an oppositely oriented dominant oblique characteristic.

6. Method according to claim 1, comprising the step of providing said raceway surface with a pattern which has screw type and/or spiral type characteristics.

7. Method according to claim 1, comprising the step of providing a grooved pattern.

8. Method according to claim 1, comprising the step of providing a discontinuous grooved pattern.

9. Method according to claim 1, comprising the step of providing a pattern having series of essentially aligned grooves or pits.

10. Method according to claim 1, comprising the step of providing a first grooved pattern on one part of the raceway surface, and a second grooved pattern on another part of the raceway surface, which raceway surface parts are next to each other in axial direction and which have oppositely oriented oblique patterns.

11. Method according to claim 1, comprising the step of providing starved lubrication conditions on said raceway surface.

12. Rolling element bearing which is lubricated according to the method of claim 1, comprising at least two rings which are each provided with raceways, as well as a at least one series of rolling elements which are in contact with said raceways, the raceway surface of at least one of the rings and rolling elements being provided with a pattern which has a dominant oblique characteristic in relation to the axis of the bearing.

13. Rolling element bearing according to claim 12, wherein the pattern has one and only one oblique characteristic in relation to the axis of the bearing on at least a portion of the raceway surface.

14. Rolling element bearing according to claim 12, wherein the pattern has at least one oblique characteristic which is more dominant than another oblique characteristic.

15. Rolling element bearing according to claim 12, wherein the pattern has a dominant oblique characteristic on a ring shaped part of the raceway surface, and a different characteristic on a further ring shaped part of the raceway.

16. Rolling element bearing according to claim 15, wherein the further ring shaped part has an oppositely oriented dominant oblique characteristic.

17. Rolling element bearing according to claim 12, wherein the raceway surface has a pattern which has screw type and/or spiral type characteristics.

18. Rolling element bearing according to claim 12, wherein the raceway surface has a grooved pattern.

19. Rolling element bearing according to claim 12, wherein the pattern comprises discontinuous grooves.

20. Rolling element bearing according to claim 19, wherein the pattern comprises series of essentially aligned grooves or pits.

21. Rolling element bearing according to claim 12, wherein a first grooved pattern is provided on one part of the raceway surface, and a second grooved pattern on another part of the raceway surface, which raceway surface parts are next to each other in axial direction and which have oppositely oriented oblique patterns.

22. Rolling element bearing according to claim 21, wherein the bearing is a line contact type rolling element bearing, e.g. a tapered roller bearing a cylindrical roller bearing, a spherical roller bearing etc.

23. Rolling element bearing according to claim 12, wherein a spiral-type grooved pattern is provided.

24. Roller element bearing according to claim 23, wherein the bearing is a tapered roller bearing, and the rolling direction of the bearing is selected such that the lubricant is driven towards the small diameter end of the bearing by the grooved pattern.

25. Roller element bearing according to claim 12, wherein the Δq value is smaller than 5°.

26. Rolling element bearing according to claim 12, wherein the dominant oblique characteristic comprises curved grooves.
